(19) United States
(12) Patent Application Publication
(10) Pub. No.: US 2026/0037007 A1
(43) Pub. Date: Feb. 5, 2026

(54) METHOD AND SYSTEM FOR DETECTING INAPPROPRIATE PILOTING RELATED TO THE SPATIAL DISORIENTATION OF AT LEAST ONE PILOT AND FOR PROTECTING AN AIRCRAFT AGAINST SAID INAPPROPRIATE PILOTING

(71) Applicant: Airbus SAS, BLAGNAC (FR)

(72) Inventors: Cécile PUISSACQ, BLAGNAC (FR); Laurent CAPRA, BLAGNAC (FR)

(21) Appl. No.: 19/288,129

(22) Filed: Aug. 1, 2025

(30) Foreign Application Priority Data
Aug. 2, 2024 (FR) FR2408600

(51) Int. Cl. G05D 1/81

(52) U.S. Cl. CPC G05D 1/815

(57) ABSTRACT

A system and a method for detecting and protecting an aircraft against inappropriate piloting by a pilot potentially experiencing spatial disorientation related to a somatogravic illusion. The method includes: obtaining flight information and status information; estimating a current value of a perceived longitudinal attitude based on the flight information; computing a difference between the current value of the perceived longitudinal attitude and a current value of an actual longitudinal attitude; and then determining, when this deviation is greater than or equal to a predetermined longitudinal attitude deviation threshold, whether a piloting action performed by the pilot is inappropriate based on the status information of the aircraft; and then activating, when the performed piloting action is inappropriate, a protective measure.

### CROSS-REFERENCES TO RELATED APPLICATIONS

This application claims the benefit of French Patent Application Number FR2408600 filed on Aug. 2, 2024, the entire disclosure of which is incorporated herein by way of reference.

### FIELD OF THE INVENTION

The field of the present disclosure relates to protecting an aircraft against inappropriate piloting by the flight crew (i.e., a pilot) when the flight crew is potentially suffering from spatial disorientation related to a sensory illusion of the “head-up” type (also known as a sensory illusion on the longitudinal axis, or a pitch sensory illusion, or even a somatogravic illusion). More specifically, the present disclosure relates to a method and a system for detecting inappropriate piloting related to the spatial disorientation of at least one pilot and for protecting an aircraft against this inappropriate piloting in the event of potential spatial disorientation related to a somatogravic illusion.

### BACKGROUND OF THE INVENTION

Under certain flight conditions, the pilots (i.e., the pilot flying and the co-pilot) of an aircraft can suffer from spatial disorientation and thus pilot the aircraft inappropriately. This is the case, for example, when aircraft accelerations can induce an inaccurate sense of longitudinal attitude (for example, during the go-around phase, when thrust is at its maximum).

This spatial disorientation can be caused by sensory illusions called “vestibular” illusions, i.e., those related to the mechanical operation of the inner ear structures and to the physical perception of movement. For example, during the “go-around” phase, the vestibular system of the pilots experiences longitudinal and vertical acceleration, which can induce “somatogravic” illusions, also called “head-up” illusions. The pilots can then suffer from longitudinal spatial disorientation, which results in an illusion of climbing or descending and is mistakenly interpreted as a vertical force resulting from the forces of gravity and inertia. In other words, the vestibular system of the pilots is affected by accelerations, which results in a difference between the actual longitudinal attitude (i.e., the pitch attitude) of the aircraft and the longitudinal attitude perceived by the pilots.

This spatial disorientation notably can be more pronounced in situations where external visual references are lost (for example, in clouds or when rain is falling on the aircraft windscreen) or in cases of intense stress, where pilots can be highly distracted and no longer refer to external visual references, even though they are still available.

In order to limit the risks related to spatial disorientation, pilots are trained not to rely on their physical perception, but to carefully monitor and trust the information provided in the cockpit. However, aircraft incidents and accidents still occur, revealing that, despite their training, pilots are subject to the influence of these sensory illusions and can pilot an aircraft based on an incorrect physical perception.

In addition, in order to comply with aircraft regulatory and certification requirements, systems exist that allow a “reduced thrust” go-around to be executed, during which longitudinal acceleration is reduced in order to limit the occurrence of somatogravic illusions during the “go-around” phase. However, this type of system does not currently allow action to be taken on vertical acceleration, which also contributes to the occurrence of sensory illusions (for example, somatogravic illusions). Therefore, there is still a risk of pilots suffering from spatial disorientation.

In another example, information systems exist for comparing the actual longitudinal attitude with the longitudinal attitude perceived by the pilots (i.e., as perceived by the vestibular system of the pilots) and, based on this comparison, for issuing a warning when the flight conditions are likely to cause the pilots to suffer from spatial disorientation. It is thus possible to predict when the pilots may become spatially disoriented and to warn them of this possibility.

However, current systems for protecting against inappropriate piloting of the aircraft related to the spatial disorientation of the pilots only take into account the detection of a risk of spatial disorientation, and not the detection of confirmed cases where the one or more pilots succumb to sensory illusions (for example, somatogravic illusions) and apply inappropriate piloting actions (for example, piloting actions intended to command the aircraft to dive that prove to be inappropriate for the current flight phase).

Therefore, overcoming these disadvantages of the prior art would be beneficial in order to improve the situation by adding protection to the current recommendations of the Authorities in order to comply with new regulatory certification constraints.

Notably, it would be beneficial to provide a solution that not only detects flight conditions conducive to the occurrence of somatogravic illusions, but that also detects situations where pilots actually show signs of succumbing to this somatogravic illusion, such as, for example, inappropriate piloting of the aircraft at the same time that such a risk of succumbing to a somatogravic illusion is detected. In addition, it would be beneficial to provide a solution that allows this inappropriate piloting of the aircraft to be corrected when the one or more pilots is/are potentially suffering from spatial disorientation.

### SUMMARY OF THE INVENTION

A method is proposed herein for detecting inappropriate piloting related to spatial disorientation related to a somatogravic illusion experienced by at least one pilot and for protecting an aircraft against said inappropriate piloting. This method is implemented in a detection and protection system comprising electronic circuitry configured to:
obtain flight information and status information of the aircraft;
estimate a current value of a perceived longitudinal attitude (Θ_{perceived}), as perceived by said at least one pilot based on said obtained flight information, according to the following formula:

$${θ}_{p e r c e i v e d} = Arc tan ( \frac{- N {x}_{{1}_{c o c k p i t}}}{N {z}_{{1}_{c o c k p i t}}} ) ,$$

where Nx1_{cockpit} is a measurement, at the time t, of the longitudinal acceleration of the aircraft, in the reference frame of the aircraft, and measured in a predefined area around the cockpit; and
where Nz1_{cockpit} is a measurement, at the time t, of the vertical acceleration of the aircraft, in the reference frame of the aircraft, and measured in the predefined area around the cockpit;
compute a difference between said current value of the perceived longitudinal attitude (Θ_{perceived}) and a current value of an actual longitudinal attitude (Θ_{actual}), which is obtained based on the obtained flight information; and then
determine, when the difference between the current value of the perceived longitudinal attitude (Θ_{perceived}) and the current value of the actual longitudinal attitude (Θ_{actual}) is greater than or equal to a predetermined longitudinal attitude deviation threshold, whether a piloting action performed by said at least one pilot is inappropriate based on the obtained status information of the aircraft; and then
activate, when the performed piloting action is inappropriate, a protective measure against inappropriate piloting.

Thus, it is possible to not only detect flight conditions conducive to the occurrence of somatogravic illusions, but also to detect whether the pilots are suffering from this somatogravic illusion and are exhibiting signs of spatial disorientation resulting in inappropriate piloting of the aircraft. As a result, it is thus possible to activate a protective measure for protecting the aircraft against such inappropriate piloting.

According to one embodiment, the protective measure is activated when the current value of the actual longitudinal attitude (Θ_{actual}) is less than or equal to a predetermined actual longitudinal attitude threshold.

According to one embodiment, activating the protective measure comprises: estimating an anticipated projection of a longitudinal attitude, also called dynamic longitudinal attitude (Θ_{dyn}), expressed by the following equation:

$${θ}_{d y n} = {θ}_{a c t u a l} + K * ( \frac{d {θ}_{a c t u a l}}{d t} ) ,$$

where Θ_{actual} is the current actual longitudinal attitude;
where K is a gain for weighting the dynamic variation of the actual longitudinal attitude Θ_{actual}.

According to one embodiment, when a current value of the dynamic longitudinal attitude (Θ_{dyn}) is greater than a predetermined minimum longitudinal attitude threshold, then the protective measure is deactivated, otherwise a control surface command is computed to correct the inappropriate piloting action of the at least one pilot.

According to one embodiment, the computed control surface command is assigned a priority level, and, when, following a vote, said priority level of the computed control surface command is higher than the priority level of at least one other different protective measure, then this control surface command is transmitted to control surface actuators of the aircraft.

According to one embodiment, when said control surface command is transmitted to said control surface actuators of the aircraft, then a warning message is also transmitted to warn the at least one pilot that said protective measure is activated.

A detection and protection system is also proposed herein for detecting inappropriate piloting related to spatial disorientation related to a somatogravic illusion experienced by at least one pilot and for protecting an aircraft against said inappropriate piloting, said detection and protection system comprising electronic circuitry configured to:
obtain flight information and status information of the aircraft;
estimate a current value of a perceived longitudinal attitude (Θ_{perceived}), as perceived by said at least one pilot based on said obtained flight information, according to the following formula:

$${θ}_{p e r c e i v e d} = Arc tan ( \frac{- N {x}_{{1}_{c o c k p i t}}}{N {z}_{{1}_{c o c k p i t}}} ) ,$$

where Nx1_{cockpit} is a measurement, at the time t, of the longitudinal acceleration of the aircraft, in the reference frame of the aircraft, and measured in a predefined area around the cockpit; and
where Nz1_{cockpit} is a measurement, at the time t, of the vertical acceleration of the aircraft, in the reference frame of the aircraft, and measured in the predefined area around the cockpit;
compute a difference between said current value of the perceived longitudinal attitude (Θ_{perceived}) and a current value of an actual longitudinal attitude (Θ_{actual}), which is obtained based on the obtained flight information; and then
determine, when the difference between the current value of the perceived longitudinal attitude (Θ_{perceived}) and the current value of the actual longitudinal attitude (Θ_{actual}) is greater than or equal to a predetermined longitudinal attitude deviation threshold, whether a piloting action performed by said at least one pilot is inappropriate based on the obtained status information of the aircraft; and then
activate, when the performed piloting action is inappropriate, a protective measure against inappropriate piloting.

An aircraft is also proposed herein comprising a detection and protection system as described above.

A computer program product is also proposed comprising instructions causing a processor to execute the aforementioned method according to any one of the embodiments thereof when said instructions are executed by the processor. A storage medium is also proposed for storing such instructions.

### BRIEF DESCRIPTION OF THE DRAWINGS

The aforementioned features of the present disclosure, as well as other features, will become more clearly apparent upon reading the following description of at least one embodiment, with said description being provided with reference to the appended drawings, in which:

FIG. 1 schematically illustrates, as a side view, an aircraft equipped with a system for detecting inappropriate piloting related to spatial disorientation of at least one pilot and for protecting an aircraft against this inappropriate piloting, according to one embodiment;

FIG. 2 schematically illustrates the system for detecting inappropriate piloting related to spatial disorientation of at least one pilot and for protecting an aircraft against this inappropriate piloting, according to one embodiment;

FIG. 3 schematically illustrates an example of a hardware platform for implementing, in the form of electronic circuitry, the system for detecting inappropriate piloting related to spatial disorientation of at least one pilot and for protecting an aircraft against this piloting, according to one embodiment;

FIG. 4 schematically illustrates various steps of a method for detecting inappropriate piloting related to spatial disorientation of at least one pilot and for protecting an aircraft against this inappropriate piloting, executed by the detection and protection system, according to one embodiment; and,

FIG. 5 schematically illustrates various steps of a method for detecting inappropriate piloting related to spatial disorientation of at least one pilot and for protecting an aircraft against this inappropriate piloting, executed by the detection and protection system, according to one embodiment.

### DETAILED DESCRIPTION OF THE PREFERRED EMBODIMENTS

The general principle of the present disclosure relates to the detection of flight conditions that can induce a somatogravic illusion causing spatial disorientation of the one or more pilots of an aircraft, as well as to the detection of proven spatial disorientation of at least one pilot. The present disclosure further relates to the correction of an inappropriate piloting action on the part of the one or more pilots of the aircraft when they are suffering from this spatial disorientation, for example, related to a somatogravic illusion.

An inappropriate piloting action on the part of the one or more pilots of the aircraft is understood to mean an action that is insufficient given the manoeuvre that should be performed (for example, a piloting action intended to command the aircraft to dive that proves to be inappropriate for the current flight phase) or a lack of action on the part of the one or more pilots of the aircraft. For example, a dive action can be considered to be a confirmed sign of a somatogravic illusion, just as a failure to pull up on the lateral control column also could be due to a somatogravic illusion and could be considered.

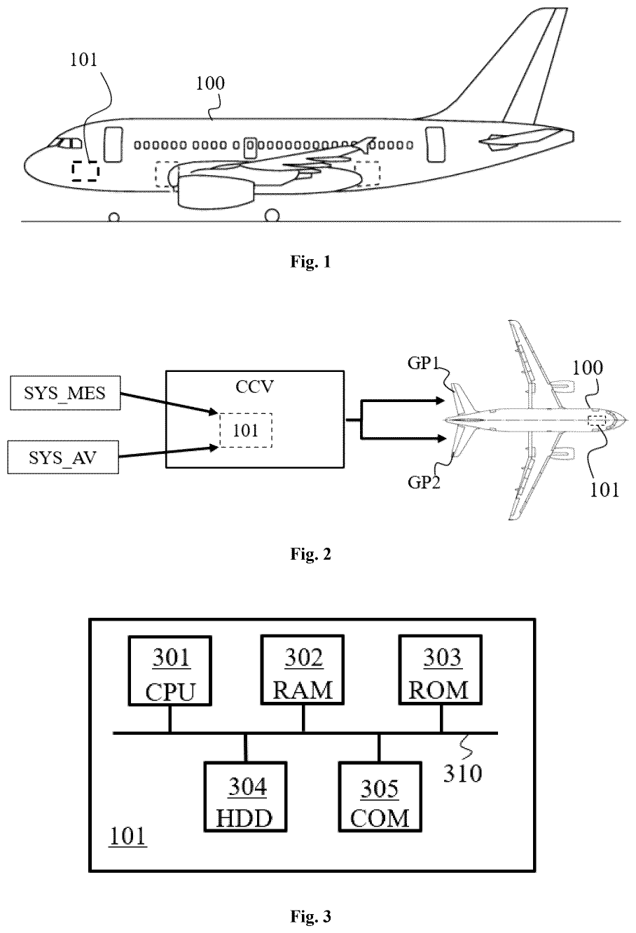

FIG. 1 thus schematically illustrates, as a side view, an aircraft 100 equipped with a system 101 (hereafter also called the detection and protection system 101) for detecting inappropriate piloting related to the spatial disorientation of at least one pilot and for protecting the aircraft 100 against this inappropriate piloting in the event of the spatial disorientation of at least one pilot, according to one embodiment. According to the embodiment of FIG. 1, the detection and protection system 101 is electronic equipment on board the aircraft 100. For example, the detection and protection system 101 forms part of the electronic circuitry of the avionics of the aircraft 100. For example, the detection and protection system 101 is integrated into a flight control computer, denoted CCV. This flight control computer CCV is, for example, a primary flight control computer.

The detection and protection system 101 is schematically and generally illustrated in FIG. 2, according to one embodiment.

This detection and protection system 101 comprises:
a first module M1 (also called monitoring module M1) for monitoring the risk of somatogravic illusion;
a second module M2 (also called detection module M2) for detecting an inappropriate action by at least one pilot;
a third module M3 (also called protection module M3) for protecting against inappropriate piloting of the aircraft 100 related to the spatial disorientation of the pilots.

It should be noted that the term “module” can equally refer to a software component, a hardware component or a set of hardware and software components, with a software component itself corresponding to one or more computer programs or sub-programs or, more generally, to any element of a program capable of implementing a function or a set of functions.

The detection and protection system 101 is configured to receive, in real-time and from a set of different measurement systems, denoted SYS_MES, flight information representing flight parameters at a given time t of the flight of the aircraft 100. These flight parameters include, for example: the geographical position of the aircraft 100, its speed, its heading, its altitude above the ground, its longitudinal attitude (i.e., the degree of pitch), its longitudinal and/or vertical acceleration in a predefined area around the cockpit of the aircraft 100, etc. Each measurement system comprises a set of sensors configured to measure one or more flight parameters of the aircraft 100 in real-time. For example, these sensors are: accelerometers, pressure sensors, gyroscopes, etc.

The detection and protection system 101 is also configured to receive information in real-time concerning the status of the aircraft 100, with the information originating from a set of various avionics systems of the aircraft 100, denoted SYS_AV. This status information represents status parameters of the aircraft 100 at the time t of flight. These status parameters include, for example: the position of one or more control components (for example, the “side-stick”) allowing the pilots (i.e., the pilot flying and the co-pilot) of the aircraft 100 to act on the longitudinal attitude of the aircraft, the model of the aircraft 100, its mass, a position of its center of gravity, a configuration of the flaps and leading edge slats, etc.

According to one embodiment, the detection and protection system 101 also can be configured to transmit a warning message to one or more warning and/or communication systems of the aircraft 100 (not shown in FIG. 2) such as: a flight warning computer (FWC), a centralized monitoring system (or Electronic Centralized Aircraft Monitoring (ECAM) system), a primary flight display (PFD), etc. This warning message notifies the pilots of the activation of a protective measure against inappropriate piloting of the aircraft 100 related to their potential spatial disorientation. In one embodiment, the warning message also notifies the pilots that a corrective measure is being taken to correct inappropriate piloting of the aircraft 100.

According to one embodiment, the detection and protection system 101 is also configured to compute, if necessary, a control surface command (for example, an elevator command) for correcting the inappropriate action performed by the one or more pilots and to issue this control surface command to the flight control controller CCV. The flight control controller CCV is configured to control the movement, via actuators (not shown in FIG. 2), of the control surfaces of the aircraft 100, such as the two elevators (denoted GP1 and GP2). In one example, the flight control controller CCV is configured to send the control surface command computed by the detection and protection system 101 to the actuators that adjust either or both of the elevators GP1 and GP2 to a particular angle, adapted to the current flight situation of the aircraft 100 (for example, an angle adapted to perform a “Go-Around” phase).

FIG. 3 schematically illustrates an example of a hardware platform for implementing the detection and protection system 101 in the form of electronic circuitry, according to one embodiment.

The hardware platform comprises, connected by a communication bus 310, a processor or CPU (Central Processing Unit) 301; a RAM (Random-Access Memory) 302; a ROM 303, for example, of the ROM (Read Only Memory) or EEPROM (Electrically-Erasable Programmable ROM) type, such as a flash memory; a storage unit, such as a hard disk drive (HDD) 304, or a storage media reader, such as a Secure Digital (SD) card reader; and an interface manager COM 305.

The interface manager COM 305 allows the detection and protection system 101 to interact with, for example, all the measurement systems SYS_MES and all the avionics systems SYS_AV of the aircraft 100. According to one embodiment, the interface manager COM 305 allows the detection and protection system 101 to interact with warning and/or communication systems of the aircraft 100, such as, for example, the FWC, the ECAM, the PFD, etc.

The processor 301 is capable of executing instructions loaded into the random-access memory 302 from the read-only memory 303, an external memory, a storage medium (such as an SD card), or a communication network. When the hardware platform is powered up, the processor 301 is capable of reading instructions from the random-access memory 302 and of executing them. These instructions form a computer program causing the processor 301 to implement all or some of the steps or methods or, more broadly, the operating sequences of the aircraft 100 described in this description.

All or some of the steps, methods and operations described herein thus can be implemented in software form by executing a set of instructions using a programmable machine, for example, a DSP (Digital Signal Processor) type processor or a microcontroller, or can be implemented in hardware form by a dedicated machine or electronic component (“chip”) or a set of dedicated electronic components (“chipset”), for example, an FPGA (“Field Programmable Gate Array”) or ASIC (“Application Specific Integrated Circuit”) component. In general, the detection and protection system 101 comprises electronic circuitry adapted and configured to implement all or some of the operations, methods and steps described herein.

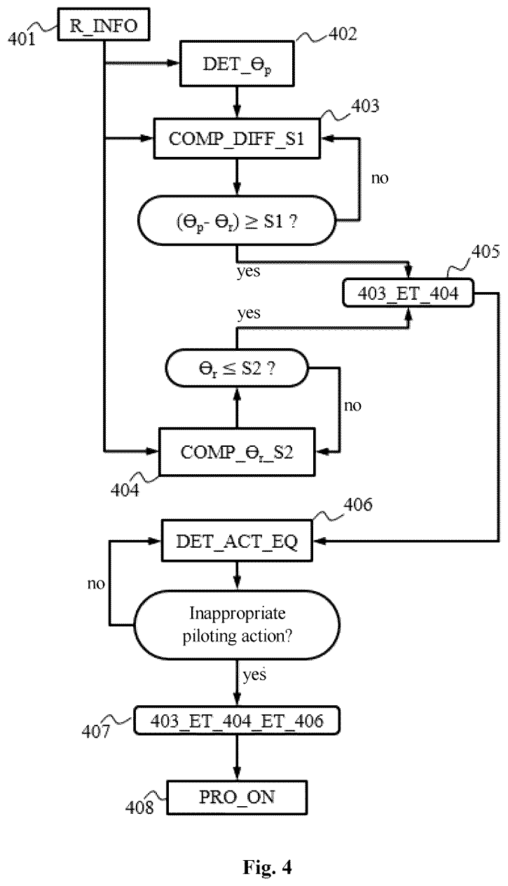

It is presented in association with FIG. 4 in the form of a diagram of the steps of a method (hereafter also called “detection and protection method”) for detecting inappropriate piloting related to spatial disorientation of at least one pilot and for protecting the aircraft 100 against this inappropriate piloting when at least one pilot is potentially experiencing spatial disorientation, according to one embodiment. All or some of this detection and protection method is implemented by the detection and protection system 101 described above.

Subsequently, by way of an example, the detection and protection method is implemented in flight conditions corresponding to a “go-around” phase. Indeed, as previously described, the longitudinal and vertical acceleration conditions of the “go-around” phase are conducive to the occurrence of somatogravic illusions that can result in the spatial disorientation of the pilots and therefore to potentially inappropriate piloting of the aircraft 100. It should be noted that the detection and protection method can be implemented in flight conditions other than those corresponding to the go-around manoeuvre (also called “go-around” phase).

From the start of the flight of the aircraft 100, i.e., as soon as the aircraft 100 is no longer in contact with the ground, during a step 401, denoted R_INFO, the detection and protection system 101 obtains, in real-time and originating from all the measurement systems SYS_MES and all the avionics systems SYS_AV of the aircraft 100, flight information and status information respectively representing flight parameters and status parameters of the aircraft 100.

According to one embodiment, the measurement systems and the avionics systems transmit this flight information and status information of the aircraft 100 to the detection and protection system 101 at a predetermined frequency. The predetermined frequency depends on the capabilities of the probes or sensors of each aircraft. According to a specific embodiment, this predetermined frequency depends on the nature of the parameter (i.e., a flight parameter or a status parameter). In one example, the transmission frequency of flight information representing a flight parameter such as longitudinal acceleration is eight points per second.

According to one embodiment, each item of flight information or of status information is filtered according to predetermined filtering criteria. For example, these filtering criteria depend on the nature of the flight parameter or status parameter. It is thus possible to avoid unintentional detection of flight conditions conducive to the onset of spatial disorientation in pilots. Consequently, it is thus possible to avoid the untimely activation of a protective measure for protecting the aircraft 100 against inappropriate piloting of the aircraft 100.

During a phase of monitoring flight conditions, the detection and protection system 101 detects, via the monitoring module M1, flight conditions conducive to the occurrence of somatogravic illusions during the “Go-Around” phase. In particular, according to one embodiment, the detection and protection system 101 monitors the longitudinal attitude of the aircraft 100.

To this end, during a step 402, denoted DET_Θₚ, the detection and protection system 101 estimates, via the monitoring module M1, a current value (i.e., at the time t) of a degree of the perceived longitudinal attitude (hereafter called “perceived longitudinal attitude”), by the pilots, denoted Θ_{perceived} (i.e., the degree of the perceived pitch attitude), according to the following formula EQ1:

$${θ}_{p e r c e i v e d} = Arc tan ( \frac{- N {x}_{{1}_{c o c k p i t}}}{N {z}_{{1}_{c o c k p i t}}} ) ,$$

where Nx1_{cockpit} is a measurement, at the time t, of the longitudinal acceleration of the aircraft 100, in the reference frame of the aircraft 100, and measured in a predefined area around the cockpit (for example, using accelerometers at the front of the aircraft 100 or installed in the cockpit); and,
where Nz1_{cockpit} is a measurement, at the time t, of the vertical acceleration of the aircraft 100, in the reference frame of the aircraft 100, and measured in the predefined area around the cockpit (for example, using accelerometers at the front of the aircraft 100 or installed in the cockpit).

This current value of perceived longitudinal attitude Θ_{perceived} corresponds to an estimated value of the longitudinal attitude of the aircraft 100 as experienced by the vestibular system of the pilots (at the position of their head).

Then, during a step 403, denoted COMP_DIFF_S1, the detection and protection system 101 determines, via the monitoring module M1, that a current flight condition is conducive to the occurrence of somatogravic illusions in the pilots. To this end, the detection and protection system 101 computes the difference between a current value of perceived longitudinal attitude Θ_{perceived} and a current value of actual longitudinal attitude (hereafter called “actual longitudinal attitude”), denoted Θ_{actual} (i.e., degree of actual pitch attitude). This difference corresponds to the deviation between the perception of the longitudinal attitude of the aircraft 100 by the pilots and the actual longitudinal attitude of the aircraft 100. It should be noted that the actual longitudinal attitude Θ_{actual} is measured by a sensor, such as a gyroscope, for example.

This difference between the current value of the perceived longitudinal attitude Θ_{perceived} and the current value of the actual longitudinal attitude Θ_{actual} is then compared with a predetermined longitudinal attitude deviation threshold, denoted S1. The order of magnitude of this predetermined longitudinal attitude deviation threshold S1 ranges between 5° and 10°. Thus, the aim in this case is to monitor the deviation between the perception of the crew of the aircraft 100 and the actual longitudinal attitude of the aircraft 100.

In a specific embodiment, this predetermined longitudinal attitude deviation threshold S1 depends on the altitude of the aircraft 100 relative to the ground at a given time, denoted time t.

Thus, if the difference between the current value of the perceived longitudinal attitude Θ_{perceived} and the current value of the actual longitudinal attitude Θ_{actual} is less than the predetermined longitudinal attitude deviation threshold S1 (i.e., a “no” response at the end of step 403), then this step 403 COMP_DIFF_S1 is repeated.

Conversely, if this difference is greater than or equal to the predetermined longitudinal attitude deviation threshold S1 (i.e., a “yes” response at the end of step 403), then the detection and protection system 101 executes a step 405, denoted 403_ET_404. Thus, when the perceived longitudinal attitude Θ_{perceived} perceived by the pilots is greater than the actual longitudinal attitude Θ_{actual} (i.e., as measured by one or more appropriate sensors), beyond the predetermined longitudinal attitude deviation threshold S1, there is a risk that the pilots will experience spatial disorientation related to a somatogravic illusion.

During step 404, denoted COMP_Θr_S2, occurring synchronously or asynchronously with step 403 COMP_DIFF_S1 described above, the detection and protection system 101 compares, via the monitoring module M1, a current value of the actual longitudinal attitude Θ_{actual} with a predetermined actual longitudinal attitude threshold, denoted S2. The order of magnitude of this predetermined actual longitudinal attitude threshold S2 ranges between 5 and 12°. It is thus possible to avoid the incorrect detection of flight conditions conducive to the occurrence of somatogravic illusions in the pilots.

In a specific embodiment, this predetermined actual longitudinal attitude threshold S2 depends on the altitude of the aircraft 100 relative to the ground at the time t.

If the current value of the actual longitudinal attitude Θ_{actual} is greater than the predetermined actual longitudinal attitude threshold S2 (i.e., a “no” response at the end of step 404), then step 404 is repeated. If, conversely, the current value of the actual longitudinal attitude Θ_{actual} is less than or equal to the predetermined actual longitudinal attitude threshold S2 (i.e., a “yes” response at the end of step 404), then the detection and protection system 101 executes step 405, denoted 403_ET_404.

During step 405, denoted 403_ET_404, the detection and protection system 101 checks, via the monitoring module M1, that at the time t, at the end of step 404 COMP_Θr_S2, the actual longitudinal attitude Θ_{actual} is less than or equal to the predetermined actual longitudinal attitude threshold S2 (i.e., a “yes” response at the end of step 404) and that, in addition, the difference between the perceived longitudinal attitude Θ_{perceived} and the actual longitudinal attitude Θ_{actual} is greater than or equal to the predetermined longitudinal attitude deviation threshold S1 (i.e., a “yes” response at the end of step 403). If both conditions are met (i.e., a “yes” response at the end of step 404 and a “yes” response at the end of step 403), then the detection and protection system 101 detects that the current flight condition is conducive to the occurrence of somatogravic illusions in the pilots.

During a phase of monitoring the piloting of the aircraft 100, the detection and protection system 101 determines, via the detection module M2, whether the piloting of the aircraft 100 by at least one pilot is inappropriate. More specifically, when flight conditions conducive to the occurrence of somatogravic illusions in the pilots are detected at the end of the flight condition monitoring phase, then the detection and protection system 101 determines whether the piloting of the aircraft 100 by at least one pilot is inappropriate.

To this end, during a step 406, denoted DET_ACT_EQ, the detection and protection system 101 detects, via the detection module M2, at the time t, that a piloting action on at least one piloting component of the aircraft 100 is being performed by at least one pilot. The detection and protection system 101 then determines whether this piloting action is inappropriate (i.e., unsuitable) for the current flight phase (for example, the go-around phase).

In one example, when the aircraft 100 is in a go-around phase, this “inappropriate” piloting action is an action intended to command the aircraft 100 to dive in order to decrease the longitudinal attitude (whereas an appropriate action would be to decrease the longitudinal attitude in order to stabilize in level flight). To this end, the detection and protection system 101 receives, from one or more avionics systems of the aircraft 100 belonging to the set of avionics systems SYS_AV, status information representing a status parameter of the aircraft 100, such as the position of the piloting components for controlling the longitudinal attitude of the aircraft 100.

Thus, in this example, if the detection and protection system 101 does not detect any action on the piloting components by the pilots or if a piloting action is detected, but it is not inappropriate given the status of the aircraft 100, and in particular the longitudinal attitude of the aircraft (i.e., a “no” response at the end of step 406), then step 406 is repeated. Conversely, if the detection and protection system 101 detects that an inappropriate piloting action, for example, an inappropriate action to dive (longitudinal) on at least one piloting component (for example, an action intended to command the aircraft 100 to dive using a piloting component, such as a side-stick, for example) is performed by at least one pilot while the longitudinal attitude of the aircraft 100 is already low (i.e., a “yes” response at the end of step 406), then the detection and protection system 101 executes a step 407, denoted 403_ET_404_ET_406.

In addition, when an inappropriate piloting action on at least one piloting component is detected, the detection and protection system 101 implements a timer that gives the pilots time to react themselves and to correct this inappropriate piloting action. In one example, the detection and protection system 101 changes a variable i from a value of 0 to 1 by applying a delay (in seconds), denoted T, which is predetermined and fixed (for example, 2 to 8 s) and/or is dependent on the altitude of the aircraft 100 and on the actual longitudinal attitude Θ_{actual}.

At the end of the phases for monitoring flight conditions (i.e., steps 402 to 405) and for monitoring the piloting of the aircraft 100 (i.e., step 406), during step 407, denoted 403_ET_404_ET_406, the detection and protection system 101 checks:
that at the end of step 404 COMP_Θr_S2, the actual longitudinal attitude Θ_{actual} is less than or equal to the predetermined actual longitudinal attitude threshold S2 (i.e., a “yes” response at the end of step 404); and
that the difference between the perceived longitudinal attitude Θ_{perceived} and the actual longitudinal attitude Θ_{actual} is greater than or equal to the predetermined longitudinal attitude deviation threshold S1 (i.e., a “yes” response at the end of step 403); and
that an inappropriate piloting action, for example, on at least one piloting component, is performed by at least one pilot (i.e., a “yes” response at the end of step 406).

Thus, when the preceding conditions are met (i.e., a “yes” response at the end of steps 403, 404 and 406), then the detection and protection system 101 detects that the one or more pilots is/are potentially experiencing spatial disorientation and is/are piloting the aircraft 100 inappropriately, probably due to this spatial disorientation.

It is thus possible, by comparing an estimate of the longitudinal attitude of the aircraft 100 as perceived by the pilots (Θ_{perceived}) with the actual longitudinal attitude of the aircraft (Θ_{actual}), to detect a situation where the pilot is potentially suffering from somatogravic illusions and, while doubtless solely relying on their own feelings rather than on their instruments or warnings from various systems (for example, the Ground Proximity Warning System or GPWS), performs inappropriate piloting actions (for example, actions intended to command the aircraft 100 to dive), which could ultimately lead to the destruction of the aircraft 100 through contact with the ground (or “Control Flight Into Terrain” or CFIT).

As a result, the detection and protection system 101 activates, via the protection module M3, during a step 408, denoted PRO_ON, the protective measure for protecting the aircraft 100 against inappropriate piloting (hereafter also called “protective measure”).

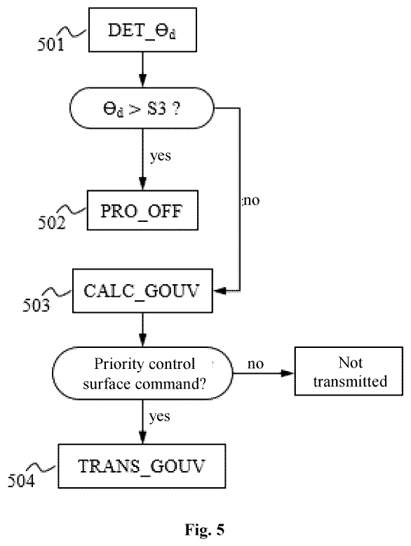

FIG. 5 shows a diagram of the steps of the detection and protection method after activating the protective measure (i.e., step 408 PRO_ON), according to one embodiment. Steps 501 and 504 described below are implemented by the detection module M3 of the detection and protection system 101.

When this protective measure is activated (i.e., step 408 PRO_ON), then, during a step 501, denoted DET_Θd, the detection and protection system 101 estimates an anticipation of the actual longitudinal attitude of the aircraft 100, taking into account its current movement at the time t, called dynamic longitudinal attitude, denoted Θ_{dyn}, using the following formula EQ2:

$${θ}_{d y n} = {θ}_{a c t u a l} + K * ( \frac{d {θ}_{a c t u a l}}{d t} ) ,$$

Where K is a gain for taking into account the dynamic variation of the actual longitudinal attitude Θ_{actual}.

Estimating the dynamic longitudinal attitude Θ_{dyn} allows the protective measure to be adjusted. For example, if the actual longitudinal attitude of the aircraft 100 is returning to more reasonable values, it is not necessary to intervene as strongly as if the actual longitudinal attitude of the aircraft 100 continues to decrease.

After estimating the dynamic longitudinal attitude, denoted Θ_{dyn}, the detection and protection system 101 compares the dynamic longitudinal attitude Θ_{dyn} with a predetermined minimum longitudinal attitude threshold, denoted S3.

In a specific embodiment, this predetermined minimum longitudinal attitude threshold S3 depends on the altitude of the aircraft 100 relative to the ground at the time t.

When a current value of the dynamic longitudinal attitude Θ_{dyn} is greater than the predetermined minimum longitudinal attitude threshold S3 (i.e., a “yes” response at the end of step 501), then the protective measure is deactivated during a step 502, denoted PRO_OFF. As a result, the detection and protection system 101 does not compute any control surface command for correcting the actual longitudinal attitude of the aircraft 100 in response to inappropriate piloting of the aircraft 100. The protective measure is no longer active since the aircraft 100 has reached the minimum target longitudinal attitude (i.e., the predetermined threshold of actual longitudinal attitude Θ_{actual}). In other words, depending on the deviation between the actual longitudinal attitude (Θ_{actual}) and the minimum target longitudinal attitude (i.e., the predetermined threshold of actual longitudinal attitude actual), the protective measure may or may not remain active. As long as a current value of the dynamic longitudinal attitude Θ_{dyn} remains less than or equal to the predetermined minimum longitudinal attitude threshold S3, the protective measure remains activated.

Conversely, when a current value of the dynamic longitudinal attitude Θ_{dyn} is less than the predetermined minimum longitudinal attitude threshold S3 (i.e., a “no” response at the end of step 501), then the detection and protection system 101 executes a step 503, denoted CALC_GOUV. In other words, the protective measure executed by the detection and protection system 101 allows, if necessary, a control surface command to be computed that is intended to correct the longitudinal attitude of the aircraft 100 in response to the inappropriate piloting of the aircraft 100 by the one or more pilots.

During step 503 CALC_GOUV, the detection and protection system 101 computes this control surface command intended for control surface actuators, such as the elevator control surfaces, in order to correct the longitudinal attitude of the aircraft 100 in response to inappropriate piloting action of the aircraft 100 by the one or more pilots.

This control surface command is computed based on certain flight information and on certain status information previously obtained during step 401 R_INFO. In particular, this control surface command depends on the value, at the time t, of the actual longitudinal attitude Θ_{actual}, the model type of the aircraft 100, the mass of the aircraft 100 and its centre of gravity at the time t, the configuration of the flaps and leading edge slats, and the value, at the time t, of various other flight parameters and status parameters of the aircraft 100. This control surface command also depends on the predetermined minimum longitudinal attitude threshold S3. In one example, this control surface command corresponds to a command to pull up the aircraft 100 in order to counteract the inappropriate dive command of at least one pilot until the aircraft 100 returns to a longitudinal attitude such that:
the immediate risk of CFIT can be considered to be sufficiently reduced;
the deviation between the actual longitudinal attitude of the aircraft 100 and the longitudinal attitude perceived by the pilots reduces the risk of suffering from spatial disorientation.

Thus, the activation of the protective measure includes:
estimating a dynamic longitudinal attitude (Θ_{dyn});
checking for a deviation between the current value of the dynamic longitudinal attitude (Θ_{dyn}) of the aircraft and a predetermined minimum longitudinal attitude threshold S3;
if necessary, computing a control surface command (for example, an elevator command) to correct the inappropriate piloting action of at least one pilot (for example, to pull up the aircraft).

At the end of step 503 CALC_GOUV, the control surface command computed by the detection and protection system 101 is assigned a priority level, for example, by a voting module of an avionics system of the aircraft 100. This priority level depends, for example, on decision-making criteria such as, for example, the command that intends to pull up the aircraft 100 the most will have the highest priority level.

The priority level of the control surface command computed by the detection and protection system 101 is then compared with other priority levels assigned to other protective measures by various avionics protection systems of the aircraft 100 (for example, the protective measure described in the patent application by the Applicant published under number FR 2986876 and describing an automatic protective measure for protecting an aircraft against the risk of collision with the ground or the sea called GCoP (acronym for “Ground Collision Protection”). These other protective measures also aim to transmit a control surface command for actuating the elevator control surfaces.

In order to select the control surface command to be applied, the voting module of an avionics system of the aircraft 100 compares, for example, the priority levels of the various control surface commands computed by the various protective measures. Thus, the control surface command with the highest priority level is selected as the priority command by the voting module and this command is applied.

If the priority level of the control surface command computed by the detection and protection system 101 is higher than the priority level of the other protective measures (for example, the control surface command computed for the GCoP protective measure), then the control surface command computed by the detection and protection system 101 takes priority. Consequently, the detection and protection system 101 executes a corrective measure for correcting the inappropriate piloting action corresponding to the transmission of the previously computed control surface command to the control surface actuators, such as the elevators of the aircraft 100, via the flight control computer CCV, during a step 504, denoted TRANS_GOUV. Conversely, if the priority level of the control surface command computed by the detection and protection system 101 is lower than the priority level of the other protective measures, then this control surface command is not transmitted and the control surface command of another protective measure is then transmitted to the elevators, for example. If the control surface command computed by the detection and protection system 101 is not a priority, this either means that another more important pull-up command has been sent by another protection system, or that the pull-up command is too important and has a lower priority than a dive command (which generally remains a priority to protect the aircraft from potentially stalling).

According to one embodiment, the detection and protection method ends after the control surface commands have been transmitted.

It should be noted that the protective measure described above should not prevent the pilot from landing the aircraft 100. Indeed, as indicated above, this protective measure is only activated in the event of a potential somatogravic illusion, which should not be the case when the pilot wishes to land because then the longitudinal acceleration of the aircraft 100 (the main contributor to the somatogravic illusion phenomenon) is low due to the selection of a reduced thrust level for the landing manoeuvre.

Thus, by virtue of this protective measure implemented by the detection and protection system 101, it is possible to supplement the current systems that are already implemented in some aircraft and that are designed to limit longitudinal acceleration during the go-around phase. In particular, this protective measure allows, if necessary, the corrective measure described above to be applied in order to correct the inappropriate piloting action of the one or more pilots.

In a specific embodiment, during the step 504 TRANS_GOUV, when the control surface command computed by the detection and protection system 101 has priority, then the detection and protection system 101 could generate a warning message for the pilots and transmit it to the warning and/or communication systems of the aircraft 100. This warning message would be intended to notify the pilots of the activation of the protective measure for protecting against inappropriate piloting of the aircraft 100. According to a specific embodiment, the warning message would also announce the execution of the corrective measure for correcting the inappropriate piloting action. The detection and protection system 101 would transmit this warning message to warning and/or communication systems of the aircraft 100, such as the ECAM, the PFD or the FWC, etc., so that this warning message is displayed and/or broadcast on a human-machine interface in the cockpit of the aircraft 100. In one example, this warning message would be a visual and/or audible notification in the form of a warning or advisory caution. Thus, the activation of this protective measure, as well as, if necessary, the execution of the corrective measure for correcting the inappropriate piloting action, would be accompanied by displaying and/or broadcasting a warning message for the pilots in order to warn them of the activation of this protective measure and, if necessary, to prompt the pilots to stop applying inappropriate dive commands.

It should be noted that experience shows that in cases of intense stress, and especially in cases where the pilot is experiencing attentional tunnelling, a warning message alone would not be useful and would be secondary to the protective (compensatory) measure. It is therefore possible to combine the warning message with the protective measure implemented by the detection and protection system 101, with this protective measure therefore being the primary means of reducing the risk of losing control of the aircraft 100.

In a specific embodiment, in addition to the predetermined minimum longitudinal attitude threshold S3, a predetermined minimum radio altitude threshold S4 is used. Thus, the lower the radio altitude, the quicker the detection of a flight condition conducive to the occurrence of somatogravic illusion has to be confirmed. Consequently, it is possible to limit this detection as a function of the altitude of the aircraft 100 at the time t.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for detecting inappropriate piloting related to spatial disorientation related to a somatogravic illusion experienced by at least one pilot and for protecting an aircraft against said inappropriate piloting, said method being implemented in a detection and protection system comprising electronic circuitry configured to:
obtain a flight information and a status information of the aircraft;
estimate a current value of a perceived longitudinal attitude (Θ_{perceived}), as perceived by said at least one pilot based on the obtained flight information, according to the following formula:
$${θ}_{p e r c e i v e d} = Arc tan ( \frac{- N {x}_{{1}_{c o c k p i t}}}{N {z}_{{1}_{c o c k p i t}}} ) ,$$
where Nx1_{cockpit} is a measurement, at a time t, of a longitudinal acceleration of the aircraft, in a reference frame of the aircraft, and measured in a predefined area around a cockpit; and
where Nz1_{cockpit} is a measurement, at the time t, of a vertical acceleration of the aircraft, in the reference frame of the aircraft, and measured in the predefined area around the cockpit;
compute a difference between said current value of the perceived longitudinal attitude (Θ_{perceived}) and a current value of an actual longitudinal attitude (Θ_{actual}), which is obtained based on the flight information; and then
determine, when the difference between the current value of the perceived longitudinal attitude (Θ_{perceived}) and the current value of the actual longitudinal attitude (Θ_{actual}) is greater than or equal to a predetermined longitudinal attitude deviation threshold (S1), whether a performed piloting action performed by said at least one pilot is inappropriate based on the status information of the aircraft; and then
activate, when the performed piloting action is inappropriate, a protective measure against inappropriate piloting.

2. The method according to claim 1, wherein said protective measure is activated when the current value of the actual longitudinal attitude (Θ_{actual}) is less than or equal to a predetermined actual longitudinal attitude threshold (S2).

3. The method according to claim 1, wherein activating said protective measure comprises: estimating an anticipated projection of a longitudinal attitude, also called dynamic longitudinal attitude (Θ_{dyn}), expressed by the following equation:
$${θ}_{d y n} = {θ}_{a c t u a l} + K * ( \frac{d {θ}_{a c t u a l}}{d t} ) ,$$
where Θ_{actual} is the current actual longitudinal attitude, and
where K is a gain for weighting a dynamic variation of the actual longitudinal attitude Θ_{actual}.

4. The method according to claim 3, wherein, when a current value of the dynamic longitudinal attitude (Θ_{dyn}) is greater than a predetermined minimum longitudinal attitude threshold (S3), then the protective measure is deactivated, otherwise a control surface command is computed to correct the inappropriate piloting of the at least one pilot.

5. The method according to claim 4, wherein the computed control surface command is assigned a priority level, and wherein, when, following a vote, said priority level of the computed control surface command is higher than the priority level of at least one other different protective measure, then said control surface command is transmitted to control surface actuators of the aircraft.

6. The method according to claim 5, wherein, when said control surface command is transmitted to said control surface actuators of the aircraft, then a warning message is transmitted to warn the at least one pilot that said protective measure is activated.

7. A detection and protection system for detecting inappropriate piloting related to spatial disorientation related to a somatogravic illusion experienced by at least one pilot and for protecting an aircraft against said inappropriate piloting, said detection and protection system comprising electronic circuitry configured to:
obtain a flight information and a status information of the aircraft;
estimate a current value of a perceived longitudinal attitude (Θ_{perceived}), as perceived by said at least one pilot based on the flight information, according to the following formula:
$${θ}_{p e r c e i v e d} = Arc tan ( \frac{- N {x}_{{1}_{c o c k p i t}}}{N {z}_{{1}_{c o c k p i t}}} ) ,$$
where Nx1_{cockpit} is a measurement, at a time t, of a longitudinal acceleration of the aircraft, in a reference frame of the aircraft, and measured in a predefined area around a cockpit, and
where Nz1_{cockpit} is a measurement, at the time t, of a vertical acceleration of the aircraft, in the reference frame of the aircraft, and measured in the predefined area around the cockpit;
compute a difference between said current value of the perceived longitudinal attitude (Θ_{perceived}) and a current value of an actual longitudinal attitude (Θ_{actual}), which is obtained based on the flight information; and then
determine, when the difference between the current value of the perceived longitudinal attitude (Θ_{perceived}) and the current value of the actual longitudinal attitude (Θ_{actual}) is greater than or equal to a predetermined longitudinal attitude deviation threshold (S1), whether a performed piloting action performed by said at least one pilot is inappropriate based on the status information of the aircraft; and
activate, when the performed piloting action is inappropriate, a protective measure against inappropriate piloting.

8. An aircraft comprising:
the detection and protection system according to claim 7.

9. A non-transitory computer readable medium storing a computer program comprising instructions which cause a processor to execute the method according to claim 1, when said instructions are executed by the processor.
